(19) United States
(12) Patent Application Publication
(10) Pub. No.: US 2005/0079260 A1
(43) Pub. Date: Apr. 14, 2005

(54) Methods for reducing astringency

(76) Inventors: John F. Sweeney, St. Michael, MN (US); Terri Jo Naber, Plymouth, MN (US); Brian D. Guthrie, Chanhassen, MN (US); Chin Hong Paul Kim, Minneapolis, MN (US); William R. Aimutis JR., Blaine, MN (US); Jane E. Friedrich, Deephaven, MN (US)

Correspondence Address: CARGILL, INCORPORATED, LAW/24, 15407 MCGINTY ROAD WEST, WAYZATA, MN, 55391, US

(21) Appl. No.: 10/918,227

(22) Filed: Aug. 13, 2004

Related U.S. Application Data
(60) Provisional application No. 60/495,554, filed on Aug. 15, 2003.

(51) Int. Cl. A23L 1/28

(52) U.S. Cl. 426/427

(57) ABSTRACT

Methods to reduce the astringency of substances such as foods and beverages are provided. Compositions exhibiting reduced astringency are also provided.

### CROSS-REFERENCE TO RELATED APPLICATIONS

This application claims all benefit under law including under 35 U.S.C. § 119 (e) of the prior U.S. provisional application Ser. No. 60/495,554, filed Aug. 15, 2003, incorporated by reference in its entirety herein.

### TECHNICAL FIELD

The invention relates to methods to modify the sensory properties of an orally ingestible substance such as a beverage, food, or pharmaceutical substance. More particularly, the invention relates to methods of using a non-reducing disaccharide, such as trehalose, to reduce the astringency of a substance. The invention also relates to compositions with reduced astringency comprising trehalose.

### BACKGROUND

Astringency is an often-disliked oral sensation resulting from certain orally ingested beverages, foods, and pharmaceutical substances. The sensation is sufficiently unpleasant to some people that it limits the consumer market for associated products. For example, although juices such as cranberry juice, grapefruit juice, and raspberry juice may provide substantial dietary benefits, many people avoid these juices because of their astringency. The problem is particularly well illustrated by cranberry juice. Studies have shown that cranberry juice can help prevent urinary tract infections, help prevent oral cavity decay, provide high antioxidant activity, provide cardiovascular health improvement, and help prevent stomach ulcers. In view of such benefits, a practical method to reduce or eliminate the astringency of cranberry juice could significantly increase its consumption.

A typical method of mitigating the astringency of a substance is to increase the sweetness of the substance. Unfortunately, increasing the sweetness only partially masks the astringency. In addition, the caloric level can be undesirably increased if the sweetness is raised by increasing a sugar component, such as sucrose or a similar sugar.

It would be valuable to the beverage, food, and pharmaceutical industries if a method were available to reduce astringency in astringent beverages, foods, and pharmaceutical substances while maintaining desirable properties, such as an appropriate sweetness level or texture. It would be also be desirable to have a reduced astringency product containing fewer calories than the original substance.

### SUMMARY OF THE INVENTON

The invention is based on the surprising discovery that a non-reducing disaccharide, such as trehalose, can be used to reduce the astringency of a substance. The invention provides methods to reduce the astringency of a substance. More particularly, the invention provides methods to reduce the astringency of orally ingested substances such as beverages, foods, pharmaceutical substances, and diagnostic substances. In addition, compositions demonstrating reduced astringency are provided.

One aspect of the invention relates to a method to reduce the astringency of a substance. A substance can be any orally-ingested substance, e.g., a food, a beverage, a pharmaceutical substance, or a diagnostic substance. The food can be jelly, jam, preserves, sauces, spreads, fruit fillings, dressings, nuts, dietary supplements, and nutritional supplements. The beverage can include tea, wine, coffee, beer, cider, alcoholic mixes, alcoholic beverages, carbonated soft drinks, malted beverages, or a fruit juice, e.g., a fruit juice such as cranberry juice, grapefruit juice, orange juice, boysenberry juice, blueberry juice, lychee juice, raspberry juice, passion fruit juice, blackcurrant juice, lemon juice, lime juice, lemon-lime juice, prune juice, gooseberry juice, loganberry juice, cherry juice, grape juice, and mixtures thereof. The pharmaceutical substance can be in the form of lozenges, cough drops, syrups, lollies, or tablets. In the method, the substance is combined with a non-reducing disaccharide, e.g., trehalose, to form a composition. The concentration of trehalose can be between 10% and 16% by weight of the composition. The astringency of the resultant composition is less than the astringency of the substance.

Compositions are also provided. Compositions can exhibit reduced astringency, e.g., as determined by a sensory taste panel. Compositions typically include a substance, e.g., a food, beverage, or pharmaceutical substance, and a non-reducing disaccharide, e.g., trehalose. In some embodiments, the composition can contain substantially no protein, e.g., less than 20% protein by weight, less than 10% protein by weight, less than 5% protein by weight, less than 1% protein by weight, or less than 0.1% protein by weight.

A further aspect of the invention relates to a method of formulating a composition, comprising mixing trehalose with a substance to form a composition.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In addition, the materials, methods, and examples are illustrative only and not intended to be limiting. All publications, patent applications, patents, and other references mentioned herein are incorporated by reference in their entirety. In case of conflict, the present specification, including definitions, will control.

The details of one or more embodiments of the invention are set forth in the accompanying tables, drawings (if any), and the description below. Other features, objects, and advantages of the invention will be apparent from the description, tables, and drawings (if any), and from the claims.

### DETAILED DESCRIPTION

Definitions

Brix—The percent concentration on a weight to weight basis of a particular solid material in an aqueous medium. The solid may be suspended in the medium, dissolved in the medium, or otherwise dispersed in the medium. For example, a cranberry concentrate of 48 brix contains 48% cranberry solids and 52% aqueous medium.

As used herein, percent is calculated as weight to weight unless otherwise specified.

Abbreviations

42HFCS—42 high fructose corn syrup. The sweetness of 42HFCS is generally accepted by those skilled in the art as being about equal that of sucrose. 42HFCS is available commercially from companies such as Cargill Inc. (Minneapolis, Minn.), ADM (Decatur, Ill.), and A. E. Staley (Decatur, Ill.).

55HFCS—55 high fructose corn syrup. The sweetness of 55HFCS is generally accepted by those skilled in the art as being about 1.05 to 1.1 times that of sucrose. 55HFCS is available commercially from companies such as Cargill Inc. (Minneapolis, Minn.), ADM (Decatur, Ill.), and A. E. Staley (Decatur, Ill.).

90UHFS—90 ultra high fructose syrup. The sweetness of 90HFCS is generally accepted by those skilled in the art as being about 1.2 to 1.3 times that of sucrose. 90UHFS is commercially available from companies such as Cargill, Inc. (Minneapolis, Minn.) and A. E. Staley (Decatur, Ill.).

HFCS—High fructose corn syrup

UHFS—Ultra high fructose syrup

The invention provides methods to reduce the astringency of orally ingested substances such as beverages, foods, pharmaceutical substances, and diagnostic substances. In addition, the invention provides compositions containing such substances in admixture with a non-reducing disaccharide, e.g., a non-reducing disaccharide known to reduce the astringency of a substance.

The term “astringency” refers to a sensory perception which involves an oral sensation often described as drying, puckering, or drawing together of tissues of the mouth. See, e.g., The American Society for Testing and Materials (Committee E-18) (defining astringency as: “the complex of sensations due to shrinking, drawing or puckering of the epithelium as a result of exposure to substances such as alums or tannins”) and Lawless and Lee American Chemical Society, August 1993: (“three component sensations within the astringent complex: a drying sensation (lack of salivary lubrication); a roughing sensation (usually perceived when the tongue comes in contact with oral tissues such as the palate); and a drawing or puckering sensation, which results from muscular tightening of the cheeks”).

An astringent sensation can result from the oral ingestion of foods and beverages, such as certain fruits, fruit juices, teas, red wines, and nuts. In addition, an astringent sensation can result from oral ingestion of certain pharmaceutical or diagnostic substances. Astringent substances can contain tannins, polyphenolics, or phenolics.

Astringency may be sensed when an astringent substance enters the mouth and during the time the substance resides in the mouth. Astringency may be sensed immediately when the substance enters the mouth or may not be sensed until shortly thereafter. It is possible for astringency to be sensed when the substance contacts the lips, even before entering the mouth. In addition, astringency may be sensed after the substance has been swallowed. Astringency has a tendency to become more pronounced with repeated oral ingestion of an astringent substance within a short period of time, such as repeated drinking.

Substances

Methods disclosed herein can reduce the astringency of substances such as foods and beverages. Suitable foods for use in the method include fruits, such as cranberry, grapefruit, orange, boysenberry, blueberry, lychee, raspberry, passion fruit, currant (e.g., blackcurrant), lemon, lime, prune, gooseberry, loganberry, cherry, and grape, and products made therefrom, such as jams, jellies, preserves, sauces, fruit fillings, and dressings. Other suitable foods include nuts, coffee, dietary supplements, and nutritional supplements. Suitable substances for use in the present invention also include beverages, such as juices from the previously mentioned fruits (e.g., cranberry juice, grapefruit juice, orange juice, boysenberry juice, blueberry juice, lychee juice, raspberry juice, passion fruit juice, currant juice, lemon juice, lime juice, lemon-lime juice, prune juice, gooseberry juice, loganberry juice, cherry juice, grape juice). Other beverages include coffee, tea, beer, wines such as red wine, alcoholic mixers, cider, carbonated soft drinks with certain preservatives (such as sodium benzoate), and malted beverages.

Other substances for use in the invention include pharmaceutical substances and diagnostic substances. Examples include tablets (such as aspirin and certain tablets containing zinc salts), lozenges, cough drops, syrups, lollies, and liquid diagnostic formulations.

Typically a beverage such as a fruit juice is available as a fruit juice cocktail or drink, as a blend of fruit juices, or as a high concentration fruit juice. A beverage may be a formulation comprising one or more of the above described fruits in whole form, in modified form, in concentrate form, or in extract form. In addition a beverage can comprise one or more sweeteners, including sugars such as sucrose, HFCS, UHFS, dextrose, sugar alcohols such as erythritol, high potency sweeteners such as aspartame, acesulfame potassium, sucralose, neotame, saccharin, stevioside, tagatose, or a combination of such sweeteners. A beverage can comprise one or more acidulants such as citric acid, malic acid, fumaric acid, phosporic acid, one or more colorants, one or more flavoring ingredients, one or more gums and/or stabilizers, one or more preservatives, water, and other ingredients commonly known to those of ordinary skill in the art. A fruit may be in a variety of physical forms, such as solid form, liquid form, powder form, dried forms, or other forms.

Any of the substances or compositions described herein can contain substantially no protein e.g., less than 20% protein by weight, less than 10% protein by weight, less than 5% protein by weight, less than 1% protein by weight, or less than 0.1% protein by weight.

Non-Reducing Disaccharides, including Trehalose

The inventors have discovered that a non-reducing disaccharide such as trehalose can be used to reduce the astringency of a substance. Compositions described herein include a non-reducing disaccharide. A non-reducing disaccharide for inclusion herein should be known to reduce the astringency of a substance. Trehalose is one example of a non-reducing disaccharide having the formula alpha-D-glucopyranosyl-alpha-D-glucopyranoside. It is a GRAS (Generally Regarded As Safe) food ingredient, typically found in mushrooms, honey, lobster, shrimp, and baker's yeast. Trehalose is a reduced intensity sweetener compared to sucrose, having a sweetening intensity 0.40-0.50 times that of sucrose. In addition it has a calorie level of 4 calories per gram; compared to a similar calorie level of 4 calories per gram for sucrose, 4 calories per gram for 42HFCS, 4 calories per gram for 55HFCS, 4 calories per gram for 90UHFS, and 4 calories per gram for crystalline fructose. Trehalose can be provided in solid, liquid, or paste form. Trehalose is easily dissolved and is soluble in water up to 40.8% at 20° C. In addition, Trehalose is stable to acid hydrolysis, has a very high glass transition temperature compared to other disaccharides, and has very low hygroscopicity.

Compositions

The invention provides compositions having reduced astringency. The compositions include a substance as described previously and a non-reducing disaccharide, e.g., a non-reducing disaccharide known to reduce the astringency of a substance, such as trehalose. The composition can exhibit an astringency that is less than that exhibited by the substance alone. Typical compositions include beverages, such as fruit juices, teas, coffees, and wines; foods such as nuts, nut products, dietary supplements, nutritional supplements, fruits, fruit-based products, and food products containing any of the same (e.g., ice creams, fruit bars, cereal bars).

Methods for Reducing Astringency

The inventors have discovered that the astringency of certain substances, such as foods, beverages, pharmaceutical substances, and diagnostic substances, can be reduced by combining a non-reducing disaccharide such as trehalose with the substance. The resulting food, beverage, pharmaceutical, or diagnostic compositions exhibit reduced astringency as compared to the substance alone. Substances and compositions can contain substantially no protein, e.g., less than 20% protein by weight, less than 10% protein by weight, less than 5% protein by weight, less than 1% protein by weight, or less than 0.1% protein by weight.

Methods for measuring astringency in a variety of substances are known to those of skill in the art. Examples include consumer taste and sensory panels, including those using labeled affective magnitude scales or hedonic scales, same-different tests, triangle tests, and focused and non-focused testing methods; see G. D. Brannan, C. S. Setser, and K. E. Kemp, “Interaction of Astringency and Taste Characteristics,” J. Sens. Studies 16(2), p. 179 (2000)).

A substance for use in the methods can typically be provided or formulated in a variety of ways. For example, the formulation of a beverage substance for use in the methods can be prepared according to standard methods. Typical techniques include mixing, stirring, pouring, co-dissolving, shearing, homogenizing, and other standard techniques. Typically, the order in which the ingredients are mixed into a beverage substance is not critical. A portion of the ingredients may even be combined, such as by co-spraying, prior to their formulation into the beverage. Details concerning specific techniques can be found in standard references such as Unit Operations in Food Processing, R L Earle, Pergammon Press, Chapter 12.

Similarly, the technique for combining a non-reducing disaccharide such as trehalose with a substance such as a beverage can vary. As one of skill in the art will recognize, the amount of non-reducing disaccharide such as trehalose to add can vary, depending on the initial astringency of a substance, the desired sweetness, textural considerations, etc. For example, trehalose can be combined with a beverage as the beverage substance is formulated or after the beverage substance has been formulated. Trehalose can be mixed into a beverage substance as a liquid, powder, or paste. Trehalose may be combined by mixing, stirring, pouring, or another technique commonly known to those having ordinary skill in the art. Typical techniques can be found in standard references such as Unit Operations in Food Processing, R L Earle, Pergammon Press, Chapter 12. Trehalose is typically in aqueous solution in a resultant beverage composition.

In one embodiment, a cranberry juice drink beverage substance is combined with a non-reducing disaccharide known to reduce the astringency of a substance to result in a cranberry juice beverage composition having reduced astringency. Typically, trehalose is used. For beverage substances such as cranberry juice, the amount of trehalose in the resultant beverage composition can range from about 0.1% to about 40%, from about 1% to about 20%, or from about 10% to 16% by weight. The amount of cranberry solids within the resultant composition can range from about 0.1% to about 25%, from about 0.5% to about 10%, or from about 1.5% to about 4%.

Depending on the sweetness desired for the resultant composition, one or more additional sweeteners can be included in a composition described herein. For example, at low concentrations of trehalose, one or more additional sweeteners may be included in a composition to provide additional sweetness. Correspondingly, at high concentrations of trehalose, an additional sweetener may not be needed. Typically, another sweetener can be included at concentrations of trehalose of about 20% or less, 16% or less, 12% or less, or 5% or less.

Use of the methods to reduce astringency in a substance such as a beverage lessens the need to mask astringency with sweeteners or other masking materials. Accordingly, a particular masking material may become more effective at a lower concentration. Such increased effectiveness can reduce the amount of masking material required, or can enable the use of a masking material previously judged ineffective. Masking materials commonly include sweeteners, such as sugars, sugar alcohols, and high potency sweeteners. Other possible masking materials include glycerol, certain glycerol compounds, monosodiumglutamate, in addition to certain other materials. If the masking material contains a sufficient amount of calories (such as sucrose or a similar sugar), a reduced amount of masking material in a particular composition may result in reduced calories for the composition. Accordingly, a composition such as a beverage can have reduced calories and reduced masking materials in addition to reduced astringency.

Methods for reducing astringency in substances such as beverages can similarly reduce astringency in substances such as foods, pharmaceutical substances, or diagnostic substances. Methods to formulate such substances are well known to those of ordinary skill in the art, as are methods for formulating mixtures of such substances with a non-reducing disaccharide such as trehalose. Typical methods include mixing dry powders, liquids, or pastes, co-drying, spray-drying, sprinkling, evaporating marinating, blending, spraying a trehalose powder, spraying a trehalose solution, homogenizing, concentrating, and emulsifying. Details concerning these and other typical methods can be found in standard references such as Unit Operations in Food Processing, R L Earle, Pergammon Press, Chapters 7, 8, and 12. Other methods include tableting, capsuling, and making candies and lozenges. Details concerning these and other typical methods can be found in standard references such as Pharmaceutical Manufacturing Encyclopedia, (Chemical Technology Review, No. 124), Marshall Sittig, 2^{nd} Edition, Noyes Publications, April 1988; or Handbook of Pharmaceutical Manufacturing Formulations: Over The Counter Drugs, Sarafaraz K. Niazi, CRC Press, October 2003. Trehalose can be homogeneously or non-homogeneously spread throughout the resultant compositions.

### EXAMPLES

Sensory Scores Used in Examples 1-24

For Examples 1-24, astringency and sweetness were rated by a panel of experts in the sensory evaluation of foods and beverages. The following scale was used:

| | |
|---|---|
| Astringency: | 1 no astringence or virtually no astringence |
| | 2 slight astringence |
| | 3 moderate astringence |
| | 4 moderately high astringence |
| | 5 high astringence |
| Sweetness | 1 no sweetness or virtually no sweetness |
| | 2 slight sweetness |
| | 3 moderate sweetness |
| | 4 moderately high sweetness |
| | 5 high sweetness |

### Example 1

### Control

A beverage was prepared containing 90% water, 2% cranberry concentrate, 8% 42HFCS, and no trehalose. The beverage was prepared at room temperature by adding the non-water ingredients to the water and stirring until all non-water ingredients were in aqueous solution. A total of 1 liter of the beverage was prepared. The beverage was orally ingested by a 5-member panel of experts. The panel concluded the beverage's astringency score was 5. In addition, the panel concluded the beverage's sweetness score was 1. Details concerning Example 1 appear in Table 1.

### Example 2

### Control

A beverage was prepared containing 86% water, 2% cranberry concentrate, 12% 42HFCS, and no trehalose. The beverage was prepared using a similar procedure to that described in Example 1. A total of about 1 liter of the beverage was prepared. A 5-member panel of experts orally ingested the beverage. The panel concluded the beverage's astringency score was 5. In addition, the panel concluded the beverage's sweetness score was 2. Details concerning Example 2 appear in Table 1.

### Example 3

A beverage was prepared containing 78% water, 2% cranberry concentrate, 20% trehalose, and no HFCS. The beverage was prepared using a similar procedure to that described in Example 1. A total of about 1 liter of the beverage was prepared. A 5-member panel of experts orally ingested the beverage. The panel concluded the beverage's astringency score was 1. In addition, the panel concluded the beverage's sweetness score was 3. Details concerning Example 3 appear in Table 1.

### Example 4

A beverage was prepared containing 82% water, 2% cranberry concentrate, 16% trehalose, and no HFCS. The beverage was prepared using a similar procedure to that described in Example 1. A total of about 1 liter of the beverage was prepared. A 5-member panel comprised of experts orally ingested the beverage. The panel concluded the beverage's astringency score was 1. In addition, the panel concluded the beverage's sweetness matched that of Example 2 and similarly the beverage's sweetness score was 2. Details concerning Example 4 appear in Table 1.

### Example 5

A beverage was prepared containing 86% water, 2% cranberry concentrate, 12% trehalose, and no HFCS. The beverage was prepared using a similar procedure to that described in Example 1. A total of about 1 liter of the beverage was prepared. A 5-member panel of experts orally ingested the beverage. The panel concluded the beverage's astringency score was 1. In addition, the panel concluded the beverage's sweetness score was 1. Details concerning Example 5 appear in Table 1.

### Example 6

A beverage was prepared containing 96% water, 2% cranberry concentrate, 2% trehalose, and no HFCS. The beverage was prepared using a similar procedure to that described in Example 1. A total of about 1 liter of the beverage was prepared. A 5-member panel of experts orally ingested the beverage. The panel concluded the beverage's astringency score was 3. In addition, the panel concluded the beverage's sweetness score was 1 (but less sweet than Ex 5). Details concerning Example 6 appear in Table 1.

TABLE 1

| | % Cranberry | | | | | |
|---|---|---|---|---|---|---|
| | Concentrate | | % 42HFCS | | Conclusion of Sensory Panel | |
| Ex | at 48 brix | % Trehalose | at 71 brix | % Water | Astringency score | Sweetness score |
| 1 | 2 | 0 | 8 | 90 | 5 | 1 |
| 2 | 2 | 0 | 12 | 86 | 5 | 2 |
| 3 | 2 | 20 | 0 | 78 | 1 | 3 |
| 4 | 2 | 16 | 0 | 82 | 1 | 2 |
| 5 | 2 | 12 | 0 | 86 | 1 | 1 |
| 6 | 2 | 2 | 0 | 96 | 3 | 1 |
| | | | | | | (but less sweet than Ex 5) |

### Discussion of Examples 1-6

This set of examples compared the astringency and sweetness of cranberry juice drinks containing either 42HFCS or trehalose. The beverages containing trehalose were consistently rated by the sensory panel as having substantially less astringency than the control beverages. The comparison of the Ex 2 control to the Ex 4 beverage of the invention is particularly meaningful, because the sweetness observed by the panel for the two beverages was equivalent. Thus, the reduction of astringency perceived by the panel is not affected by a perceived change in sweetness.

### Example 7

### Control

A beverage was prepared containing 78% water, 4% cranberry concentrate, 0% trehalose, and 18% 42HFCS. The beverage was prepared at room temperature by adding the non-water ingredients to the water and stirring until all non-water ingredients were in aqueous solution. A total of 1 liter of the beverage was prepared. The beverage was orally ingested by a 5-member panel of experts. The panel concluded the beverage's astringency score was 5. In addition, the panel concluded the beverage's sweetness score was 4. Details concerning Example 7 appear in Table 2.

### Example 8

A beverage was prepared containing 82% water, 4% cranberry concentrate, 2% trehalose, and 12% 90UHFS. The beverage was prepared using a similar procedure to that described in Example 7. A total of 1 liter of the beverage was prepared. The beverage was orally ingested by a 5-member panel of experts. The panel concluded the beverage's astringency score was 2. In addition, the panel concluded the beverage's sweetness score was 3. Details concerning Example 8 appear in Table 2.

TABLE 2

| | | | | | | Conclusion | |
|---|---|---|---|---|---|---|---|
| | % Cranberry | | | | | of Sensory Panel | |
| | Concentrate | | % 42HFCS | % 90UHFS | | Astringency | Sweetness |
| Ex | at 48 brix | % Trehalose | at 71 brix | at 76 brix | % Water | score | score |
| 7 | 4 | 0 | 18 | 0 | 78 | 5 | 4 |
| 8 | 4 | 2 | 0 | 12 | 82 | 2 | 3 |

### Discussion of Examples 7 and 8

This set of examples compared the astringency and sweetness of cranberry juice drinks containing either 42HFCS or a mixture of 90UHFS and trehalose. The beverage containing trehalose was rated by the sensory panel as having substantially less astringency than the control beverage.

### Example 9

### Control

A beverage was prepared containing 98.1% water, 1% raspberry concentrate powder, 0% trehalose, and 0.9% 42HFCS. The beverage was prepared at room temperature by adding the non-water ingredients to the water and stirring until all non-water ingredients were in aqueous solution. A total of 1 liter of the beverage was prepared. A 5-member panel of experts orally ingested the beverage. The panel concluded the beverage's astringency score was 4. In addition, the panel concluded the beverage's sweetness score was 2. Details concerning Example 9 appear in Table 3.

### Example 10

A beverage was prepared containing 97% water, 1% raspberry concentrate powder, 2% trehalose, and 0% HFCS. The beverage was prepared using a similar procedure to that described in Example 9. A total of 1 liter of the beverage was prepared. A 5-member panel of experts orally ingested the beverage. The panel concluded the beverage's astringency score was 2. In addition, the panel concluded the beverage's sweetness score was 2. Details concerning Example 10 appear in Table 3.

### Example 11

### Control

A beverage was prepared containing 98.1% water, 1% passion fruit concentrate powder, 0% trehalose, and 0.9% 42HFCS. The beverage was prepared using a similar procedure to that described in Example 9. A total of 1 liter of the beverage was prepared. A 5-member panel of experts orally ingested the beverage. The panel concluded the beverage's astringency score was 5. In addition, the panel concluded the beverage's sweetness score was 2. Details concerning Example 11 appear in Table 3.

### Example 12

A beverage was prepared containing 97% water, 1% passion fruit concentrate powder, 2% trehalose, and 0% HFCS. The beverage was prepared using a similar procedure to that described in Example 9. A total of 1 liter of the beverage was prepared. A 5-member panel of experts orally ingested the beverage. The panel concluded the beverage's astringency score was 2. In addition, the panel concluded the beverage's sweetness score was 2. Details concerning Example 12 appear in Table 3.

### Example 13

### Control

A beverage was prepared containing 98.1% water, 1% blackcurrant concentrate powder, 0% trehalose, and 0.9% 42HFCS. The beverage was prepared using a similar procedure to that described in Example 9. A total of 1 liter of the beverage was prepared. A 5-member panel of experts orally ingested the beverage. The panel concluded the beverage's astringency score was 4. In addition, the panel concluded the beverage's sweetness score was 2. Details concerning Example 13 appear in Table 3.

### Example 14

A beverage was prepared containing 97% water, 1% blackcurrant concentrate powder, 2% trehalose, and 0% HFCS. The beverage was prepared using a similar procedure to that described in Example 9. A total of 1 liter of the beverage was prepared. A 5-member panel of experts orally ingested the beverage. The panel concluded the beverage's astringency score was 2. In addition, the panel concluded the beverage's sweetness score was 2. Details concerning Example 14 appear in Table 3.

TABLE 3

| | | | | | Conclusion | |
|---|---|---|---|---|---|---|
| | | | | | of Sensory Panel | |
| | % Juice | % | % 42HFCS | | Astringency | Sweetness |
| Ex | Concentrate Powder | Trehalose | at 71 brix | % Water | score | score |
| 9 | 1% raspberry | 0 | 0.9 | 98.1 | 4 | 2 |
| 10 | 1% raspberry | 2 | 0 | 97 | 2 | 2 |
| 11 | 1% passion fruit | 0 | 0.9 | 98.1 | 5 | 2 |
| 12 | 1% passion fruit | 2 | 0 | 97 | 2 | 2 |
| 13 | 1% blackcurrant | 0 | 0.9 | 98.1 | 4 | 2 |
| 14 | 1% blackcurrant | 2 | 0 | 97 | 2 | 2 |

### Discussion of Examples 9-14

This set of examples compared the astringency and sweetness of raspberry juice, passion fruit juice, and blackcurrant juice drinks containing either 42HFCS or trehalose. The beverages containing trehalose were consistently rated by the sensory panel as having substantially less astringency than the control beverages.

### Example 15

### Control

A beverage was prepared containing 88% water, 2% passion fruit concentrate spray dried powder, 0% trehalose, and 10% 42HFCS. The beverage was prepared at room temperature by adding the non-water ingredients to the water and stirring until all non-water ingredients were in aqueous solution. A total of 0.250 liters of the beverage was prepared. A four member panel of experts orally ingested the beverage. The panel concluded the beverage's astringency score was 5. In addition, the panel concluded the beverage's sweetness score was 3. Details concerning Example 15 appear in Table 4.

### Example 16

A beverage was prepared containing 82% water, 2% passion fruit concentrate spray dried powder, 16% trehalose, and 0% HFCS. The beverage was prepared using a similar procedure to that described in Example 15. A total of 0.250 liters of the beverage was prepared. A four member panel of experts orally ingested the beverage. The panel concluded the beverage's astringency score was 1. In addition, the panel concluded the beverage's sweetness score was 3. Details concerning Example 16 appear in Table 4.

### Example 17

### Control

A beverage was prepared containing 88% water, 2% raspberry concentrate spray dried powder, 0% trehalose, and 10% 42HFCS. The beverage was prepared using a similar procedure to that described in Example 15. A total of 0.250 liters of the beverage was prepared. A four member panel of experts orally ingested the beverage. The panel concluded the beverage's astringency score was 4. In addition, the panel concluded the beverage's sweetness score was 3. Details concerning Example 17 appear in Table 4.

### Example 18

A beverage was prepared containing 82% water, 2% raspberry concentrate spray dried powder, 16% trehalose, and 0% HFCS. The beverage was prepared using a similar procedure to that described in Example 15. A total of 0.250 liters of the beverage was prepared. A four member panel of experts in the art orally ingested the beverage. The panel concluded the beverage's astringency score was 1. In addition, the panel concluded the beverage's sweetness score was 3. Details concerning Example 18 appear in Table 4. The trehalose containing beverage was also judged to have more fruity flavor notes.

### Example 19

### Control

A beverage was prepared containing 88% water, 2% blackcurrant concentrate spray dried powder, 0% trehalose, and 10% 42HFCS. The beverage was prepared using a similar procedure to that described in Example 15. A total of 0.250 liters of the beverage was prepared. A four member panel of experts orally ingested the beverage. The panel concluded the beverage's astringency score was 4. In addition, the panel concluded the beverage's sweetness score was 3. Details concerning Example 19 appear in Table 4.

### Example 20

A beverage was prepared containing 82% water, 2% blackcurrant concentrate spray dried powder, 16% trehalose, and 0% HFCS. The beverage was prepared using a similar procedure to that described in Example 15. A total of 0.250 liters of the beverage was prepared. A 4 member panel of experts orally ingested the beverage. The panel concluded the beverage's astringency score was 1. In addition, the panel concluded the beverage's sweetness score was 3. Details concerning Example 20 appear in Table 4. The trehalose containing sample was also judged to have more fruity flavor notes.

### Example 21

### Control

A beverage was prepared containing 88% water, 2% grapefruit concentrate spray dried powder, 0% trehalose, and 10% 42HFCS. The beverage was prepared using a similar procedure to that described in Example 15. A total of 0.250 liters of the beverage was prepared. A 4 member panel of experts orally ingested the beverage. The panel concluded the beverage's astringency score was 5. In addition, the panel concluded the beverage's sweetness score was 3. Details concerning Example 21 appear in Table 4.

### Example 22

A beverage was prepared containing 82% water, 2% grapefruit concentrate spray dried powder, 16% trehalose, and 0% HFCS. The beverage was prepared using a similar procedure to that described in Example 15. A total of 0.250 liters of the beverage was prepared. A 4 member panel of experts orally ingested the beverage. The panel concluded the beverage's astringency score was 1. In addition, the panel concluded the beverage's sweetness score was 3. Details concerning Example 22 appear in Table 4. The grapefruit flavor was also enhanced in the trehalose containing beverage.

### Example 23

### Control

A beverage was prepared containing 88% water, 2% lemon concentrate spray dried powder, 0% trehalose, and 10% 42HFCS. The beverage was prepared using a similar procedure to that described in Example 15. A total of 0.250 liters of the beverage was prepared. A four member panel of experts orally ingested the beverage. The panel concluded the beverage's astringency score was 5. In addition, the panel concluded the beverage's sweetness score was 3. Details concerning Example 23 appear in Table 4.

### Example 24

A beverage was prepared containing 82% water, 2% lemon concentrate spray dried powder, 16% trehalose, and 0% HFCS. The beverage was prepared using a similar procedure to that described in Example 15. A total of 0.250 liters of the beverage was prepared. A four member panel of experts orally ingested the beverage. The panel concluded the beverage's astringency score was 1. In addition, the panel concluded the beverage's sweetness score was 3. Details concerning Example 24 appear in Table 4.

TABLE 4

| | | | | | Conclusion | |
|---|---|---|---|---|---|---|
| | | | | | of Sensory Panel | |
| | % Juice | % | % 42HFCS | | Astringency | Sweetness |
| Ex | Concentrate Powder | Trehalose | at 71 brix | % Water | score | score |
| 15 | 2% passion fruit | 0 | 10 | 88 | 5 | 3 |
| 16 | 2% passion fruit | 16 | 0 | 82 | 1 | 3 |
| 17 | 2% raspberry | 0 | 10 | 88 | 4 | 3 |
| 18 | 2% raspberry | 16 | 0 | 82 | 1 | 3 |
| 19 | 2% blackcurrant | 0 | 10 | 88 | 4 | 3 |
| 20 | 2% blackcurrant | 16 | 0 | 82 | 1 | 3 |
| 21 | 2% grapefruit | 0 | 10 | 88 | 5 | 3 |
| 22 | 2% grapefruit | 16 | 0 | 82 | 1 | 3 |
| 23 | 2% lemon | 0 | 10 | 88 | 5 | 3 |
| 24 | 2% lemon | 16 | 0 | 82 | 1 | 3 |

### Discussion of Examples 15-24

This set of examples compared the sweetness and astringency of passion fruit juice, raspberry juice, blackcurrant juice, grapefruit juice, and lemon juice drinks containing either 42HFCS or trehalose. The beverages containing trehalose were consistently rated by the sensory panel as having substantially less astringency than the control beverages.

It should be observed that the comparisons are particularly meaningful, because the sweetness observed by the panel for the two beverages for each pair (e.g., the beverage containing trehalose and its associated control) was equivalent. Hence the reduction of astringency perceived by the panel is not affected by a perceived change in sweetness.

It has further been found that addition of trehalose to certain alcoholic beverages has a desirable smoothing effect on the beverage. In this context, “smooth” is a rounding of the flavor profile. In other terms, an acute spike in flavor is extended or rounded, lessening the perceived sharpness of the flavor. Smoothness characteristics include reduction of a fiery, smoky and bitter sensation. It has additionally been found that alcohol burn is lessened. In this context, “alcohol burn” is a sensation experienced in the throat upon and after ingestion of the alcoholic beverage. In other terms, it is a fiery sensation. Alcohol burn is typically more severe with beverages that have a higher alcoholic content and are more pure, with less mixers or ingredients diluting the alcohol.

For examples 25-54, a commercially available alcoholic beverage, or a formulation similar to a commercially available beverage, was orally ingested by a panel of technologists skilled in beverage formulations. The panel included alcohol beverage technologists, and in certain cases soft drink technologists and dairy technologists. In each set of the examples the control was the beverage in its normal state, without additions, ingested at room temperature. In each set a first sample was made by mixing 0.01% by weight of trehalose into the beverage, and a second sample was made by mixing 0.10% by weight of trehalose into the beverage. The control beverage and then the 0.01% and 0.10% beverages were orally ingested. The panel members each cleansed their palates with water between each beverage.

After each sample was ingested, the panel members recorded their perceptions. The results are presented in Table 5.

TABLE 5

| | APPLICATION TYPE | DOSE | |
|---|---|---|---|
| EX | (abv = alcohol by volume) | RATE | RESULTS |
| 25 | Irish cream Liquor Type 17% abv | 0 | Control |
| 26 | Irish cream Liquor Type 17% abv | 0.01% | Smooth, less raw alcohol, |
| | | | reduced aroma, flavor change |
| | | | effect |
| 27 | Irish cream Liqueur Type 17% | 0.10% | Smooth, reduced aroma, flavor |
| | | | change effect |
| 28 | White Chocolate Cream 17% abv | 0 | Control |
| 29 | White Chocolate Cream 17% abv | 0.01% | Smooth, balanced |
| 30 | White Chocolate Cream 17% abv | 0.10% | Smooth, bodied, enhanced |
| | | | luxury mouthfeel, balanced |
| 31 | Vodka 40% | 0 | Control |
| 32 | Vodka 40% | 0.01% | Less fiery |
| 33 | Vodka 40% | 0.10% | Less fiery, smoother, flavour |
| | | | altered |
| 34 | Flavoured Vodka - Vanilla 40% abv | 0 | Control |
| 35 | Flavoured Vodka - Vanilla 40% abv | 0.01% | Smooth but flavor timing altered |
| 36 | Flavoured Vodka Smooth - Vanilla | 0.10% | Smooth but flavor timing altered |
| 37 | Whiskey Irish 40% abv Jamesons | 0 | Control |
| 38 | Whiskey Irish 40% abv Jamesons | 0.01% | Reduce aroma, reduced flavor, |
| | | | less fiery |
| 39 | Whiskey Irish 40% abv Jamesons | 0.10% | Reduce aroma, reduced flavor, |
| | | | timing different |
| 40 | Sour Mash 40% abv Jack Daniels | 0 | Control |
| 41 | Sour Mash 40% abv Jack Daniels | 0.01% | Reduced aroma, flavor same, |
| | | | less smoky |
| 42 | Sour Mash 40% abv Jack Daniels | 0.10% | Reduced aroma, reduced flavor, |
| | | | less smoky |
| 43 | FAB - Reef Type 10% juice 5% abv | 0 | Control |
| 44 | FAB - Reef Type 10% juice 5% abv | 0.01% | Cranberry - flavor timing |
| | | | difference |
| 45 | FAB - Reef Type 10% juice 5% abv | 0.10% | Cranberry - less astringent dry, |
| | | | flavor timing altered, chemical |
| 46 | FAB - Reef Type 10% juice 5% abv | 0 | Control |
| 47 | FAB - Reef Type 10% juice 5% abv | 0.01% | Orange & Passionfruit - not |
| | | | much difference |
| 48 | FAB - Reef Type 10% juice 5% abv | 0.10% | Orange & Passionfruit - rounded |
| | | | flavor, more body, sweeter |
| 49 | Lager - Budweiser 5.0% abv | 0 | Control |
| 50 | Lager - Budweiser 5.0% abv | 0.01% | Reduced bitterness, more body |
| 51 | Lager - Budweiser 5.0% abv | 0.03% | Slimy texture, salty |
| 52 | Guinness 4.2% abv | 0 | Control |
| 53 | Guinness 4.2% abv | 0.01% | Reduced bitterness |
| 54 | Guinness 4.2% abv | 0.10% | Reduced bitterness, less |
| | | | balanced |

### Discussion of Examples 25-54

These examples compared a commercial or equivalent alcoholic beverage with the same beverage having trehalose added in a controlled amount. The results generally indicate characteristics of increased smoothness and lessened throat burn. Examples 25-30, comprising a dairy component, particularly evidence increased smoothness with the addition of trehalose. Examples 31-33, unflavored vodka, particularly evidence lessened throat burn with the addition of trehalose. Examples 34-36, vanilla flavored vodka, particularly evidence smoothness and an altered flavor timing with the addition of trehalose. Examples 37-42, the whiskeys, evidence characteristics of smoothness, and some lessening of throat burn, with the addition of trehalose. These samples also evidenced reduced aroma. Examples 43-47, the alcoholic juice beverages, indicated a complex combination of characteristic modifications including particularly less astringency in the case of sample number 45. Examples 48-53, the beers/ales, evidenced particularly a reduced bitterness, which also may be a less desirable characteristic in these beverages.

Generally, the addition of trehalose can contribute to a lessening of throat burn and enhanced smoothness in alcoholic beverages. These characteristics were experienced by the panel for both the 0.01% examples and the 0.10% examples. The results in Table 5 also indicate that additional effects were brought about through the addition of trehalose. These included effects indicative of enhanced smoothness, and such effects as reduced aroma, flavor modification, enhanced luxury mouth feel, and alteration of flavor timing. Additional effects include reduced bitterness and more body. Thus, depending upon the desired product qualities, trehalose can be added to certain alcoholic beverages to not only reduce throat burn, but also to enhance smoothness and to modify other desired characteristics such as those indicated.

A number of embodiments of the invention have been described. Nevertheless, it will be understood that various modifications may be made without departing from the spirit and scope of the invention. Accordingly, other embodiments are within the scope of the following claims.

1. A method to reduce the astringency of a substance, said method comprising:
combining a non-reducing disaccharide with said substance to form a composition, wherein the astringency of said composition is less than the astringency of said substance.

2. The method of claim 1, wherein said substance comprises a food, a beverage, a pharmaceutical substance, or a diagnostic substance.

3. The method of claim 1, wherein said substance is a substance that creates a sensation of astringency when orally ingested.

4. The method of claim 1, wherein said non-reducing disaccharide comprises trehalose.

5. The method of claim 1, wherein said substance comprises a compound selected from the group consisting of tannins, polyphenolic compounds, and phenolic compounds.

6. The method of claim 2, wherein said beverage comprises fruit juice.

7. The method of claim 6, wherein said fruit juice is selected from the group consisting of cranberry juice, grapefruit juice, orange juice, boysenberry juice, blueberry juice, lychee juice, raspberry juice, passion fruit juice, blackcurrant juice, lemon juice, lime juice, lemon-lime juice, prune juice, gooseberry juice, loganberry juice, cherry juice, grape juice, and mixtures thereof.

8. The method of claim 2, wherein said beverage comprises tea, wine, coffee, beer, cider, alcoholic mixes, alcoholic beverages, carbonated soft drinks, or malted beverages.

9. The method of claim 2, wherein said pharmaceutical substance is in the form of lozenges, cough drops, syrups, bollies, or tablets.

10. The method of claim 2, wherein said food is selected from the group consisting of jelly, jam, preserves, sauces, spreads, fruit fillings, dressings, nuts, dietary supplements, and nutritional supplements.

11. The method of claim 4, wherein the concentration of said trehalose is between about 10% and about 16% by weight of said composition.

12. A composition comprising:
a. a substance selected from the group consisting of a food, a beverage, a pharmaceutical substance, and a diagnostic substance; and
b. a non-reducing disaccharide, wherein said composition comprises substantially no protein.

13. The composition of claim 12, wherein said non-reducing disaccharide is trehalose.

14. The composition of claim 12, wherein said composition comprises less than 0.1% protein.

15. The composition of claim 12, wherein said substance is a beverage.

16. The composition of claim 15, wherein said beverage substance comprises a fruit juice selected from the group consisting of cranberry juice, grapefruit juice, orange juice, boysenberry juice, blueberry juice, lychee juice, raspberry juice, passion fruit juice, blackcurrant juice, lemon juice, lime juice, lemon-lime juice, prune juice, gooseberry juice, loganberry juice, cherry juice, grape juice, and mixtures thereof.

17. A method of formulating a beverage composition comprising mixing a non-reducing disaccharide with a beverage substance to form a beverage composition, wherein said beverage composition comprises substantially no protein.

18. The method of claim 17, wherein said beverage composition comprises less than 0.1% protein.

19. The method of claim 17, wherein said beverage substance comprises fruit juice.

20. The method of claim 19, wherein said fruit juice comprises cranberry juice.

21. The method of claim 17, wherein the concentration of said non-reducing disaccharide in said beverage composition is between about 10% and about 16% by weight.

22. The method of claim 21, wherein said non-reducing disaccharide is trehalose.

23. The method of claim 1, wherein said non-reducing disaccharide is trehalose.

24. A method to reduce the astringency of a substance, said method comprising:
combining trehalose with said substance to form a composition, wherein the astringency of said composition is less than the astringency of said substance.

25. The method of claim 24 wherein said substance is at least one of a food, a beverage, a pharmaceutical substance and a diagnostic substance.

26. The method of claim 24 wherein said substance creates a sensation of astringency when orally ingested.

27. The method of claim 24 wherein said combining comprises combining between about 10% and about 16% by weight of trehalose with said substance.

28. A composition comprising:
a. a substance selected from the group consisting of a food, a beverage, a pharmaceutical, a diagnostic substance and combinations thereof; and
b. trehalose,
wherein said composition comprises essentially no protein.

29. The composition of claim 28 wherein the astringency of said composition upon oral ingestion is less than the astringency of said substance upon oral ingestion.

30. The composition of claim 28 wherein said composition comprises between about 10% and about 16% by weight of trehalose.

31. A method of reducing alcohol burn in an alcoholic beverage comprising combining a non-reducing disaccharide with said alcoholic beverage.

32. A method of reducing alcohol burn in an alcoholic beverage comprising combining trehalose with said alcoholic beverage.

33. The method of claim 32 wherein said trehalose is combined with said alcoholic beverage in an amount between about 0.01% and 0.10% by weight.

34. An alcoholic beverage comprising trehalose and having reduced alcoholic burn upon oral ingestion.

35. An alcoholic beverage comprising between about 0.01% and 0.10% by weight of trehalose.

36. A method of increasing smoothness in an alcoholic beverage comprising combining a non-reducing disaccharide with said alcoholic beverage.

37. A method of increasing smoothness in an alcoholic beverage comprising combining trehalose with said alcoholic beverage.

38. The method of claim 37 wherein said trehalose is combined with said alcoholic beverage in an amount between about 0.01% and 0.10% by weight.
